(19) United States
(12) Patent Application Publication
(10) Pub. No.: US 2007/0153310 A1
(43) Pub. Date: Jul. 5, 2007

(54) Image forming method and apparatus for borderless printing

(75) Inventor: Young-do Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/606,038

(22) Filed: Nov. 30, 2006

(30) Foreign Application Priority Data
Jan. 4, 2006 (KR) 2006-879

(51) Int. Cl. G06K 15/00

(52) U.S. Cl. 358/1.12; 358/1.2

(57) ABSTRACT

A borderless printing method and an image forming apparatus are provided for printing an image on a printable medium without a margin. The method includes: setting a print size of a print image and a print area of the print image out of an image magnified than the print size for the borderless printing; and printing the print image according to the set print area. Accordingly, when borderless printing is performed using an image forming apparatus, by allowing a user to adjust a position of a print area of a print image to be actually printed on a medium out of an image magnified than the size of the medium for the borderless printing, user convenience can be increased by easily preventing image data of an area desired by the user from not being printed, and by not driving write components of a printer head corresponding to marginal areas, power consumption can be reduced.

### CROSS-REFERENCE TO RELATED APPLICATIONS

This application claims all benefits accruing under 35 U.S.C. §119 from Korean Application No. 2006-879, filed Jan. 4, 2006, in the Korean Intellectual Property Office, the disclosure of which is incorporated herein by reference.

### BACKGROUND OF THE INVENTION

1. Field of the Invention

The present invention relates to an image forming apparatus and method for printing an image on a printable medium, and more particularly, to an image forming apparatus and method for borderless printing, by which an image is printed on a printable medium without a margin.

2. Related Art

Image forming apparatuses, such as printers, photocopiers, facsimile machines and multi-functional products, generally have a function of converting a document edited by a user using an application program and requested to print into encoded data, and printing the encoded data on paper in a user-readable pattern.

Recently, photo printers have become available on the market to print a photographic image taken by a digital camera using printing techniques, such as an inkjet method, a dye sublimation thermal transfer method, and a direct thermal method. Such a photo printer includes a printing unit for printing an image on a printable medium, and a transfer unit for transferring the printable medium. The printing unit is typically an inkjet head in the case of an inkjet printer, or a thermal printing head (TPH) in the case of a dye sublimation thermal transfer printer or a direct thermal printer.

Borderless printing is necessary in order to print a photographic image. For the borderless printing, a printable medium, such as a photo paper, used for a photo printer has an upper perforated line and a lower perforated line for setting tab areas in the top and bottom portions of a photographic image, respectively, and has a print area between the upper perforated line and the lower perforated line. Commonly, a borderless-printed photographic image can be obtained by printing an image having a little bit larger size than the print area on a printable medium with setting marginal areas on the top, bottom, left, and right portions of the image, which are actually not printed on the printable medium, and cutting off the tab areas along the upper perforated line and the lower perforated line.

In particular, a first distance between the top end of a print medium and the upper perforated line and a second distance between the top end of the print medium and the lower perforated line are determined as fixed values. A first time and a second time required to transfer the print medium by the first distance and the second distance are determined according to a transfer speed of the print medium. When the print medium is fed, the top end of the print medium is detected by a position sensor, a printing job starts by setting a position corresponding to the first time as a print start position, and the printing job ends by setting a position corresponding to the second time as a print end position.

When borderless printing is performed using the conventional printing method as described above, there are several deficiencies noted. First, since an image larger than a printable medium is printed without any interaction, date in the bottom area of an image, which a user desires to be printed along with the image, may not be printed on a printable medium at all. Secondly, since write components of a printer head are driven for even marginal areas of a printable medium, which are actually not printed on the print medium, power is wasted.

### SUMMARY OF THE INVENTION

Several aspects and example embodiments of the present invention provide an image forming method and apparatus for borderless printing, by which a user can adjust a position of a marginal area, which is not printed in the borderless printing, and power consumption while printing can be reduced.

Additional aspects and/or advantages of the invention will be set forth in part in the description which follows and, in part, will be obvious from the description, or may be learned by practice of the invention.

In accordance with an embodiment of the present invention, there is provided an image forming method for borderless printing. Such a method comprises: setting a print size of a print image and a print area of the print image out of an image magnified than the print size for the borderless printing; and printing the print image on a printable medium according to the set print area.

According to an aspect of the present invention, during the setting of the print area, a position of the print area may be input for at least one of top, bottom, left, and right portions of the print image, or a position of one of vertices of the print area may be input.

According to an aspect of the present invention, the method may further comprise displaying the print image with marginal areas having input widths or displaying only the print image in the print area, which will be printed on a printable medium, from the magnified image.

According to an aspect of the present invention, the printing may comprise: shifting print image data representing the print image on each print line according to the widths input for marginal areas of a main scanning direction; and printing the print image by driving write components of a printer head using the shifted print image data.

According to an aspect of the present invention, during the printing, write components of the printer head corresponding to one of the two marginal areas of the main scanning direction may be not driven.

According to an aspect of the present invention, the printing may comprise: determining a print start position of the print image according to the widths input for marginal areas of a sub scanning direction; and printing the print image according to the determined print start position.

In accordance with another embodiment of the present invention, there is provided an image forming apparatus for borderless printing, comprising: a user input unit arranged to enable a user to set a print size of a print image and a print area of the print image from an image magnified than the print size for the borderless printing; a controller arranged to adjust data of the print image according to the set print area; and a printing unit arranged to print the print image on a printable medium using the adjusted print image data.

According to an aspect of the present invention, the user input unit may receive a position of the print area for at least one of top, bottom, left, and right portions of the print image or a position of one of vertices of the print area.

According to an aspect of the present invention, a display unit may be included to provide a visual display of the print image with marginal areas having input widths.

According to an aspect of the present invention, the printing unit may comprise: a printer head arranged to print the print image using a plurality of write components; and a line buffer arranged to store print image data of a single print line corresponding to each of the write components, wherein the controller shifts the print image data stored in the line buffer according to the input widths for marginal areas of a main scanning direction.

According to an aspect of the present invention, the printer head may not drive write components corresponding to the marginal areas of the main scanning direction, and the controller may determine a print start position of the print image according to the widths input for marginal areas of a sub scanning direction. The image forming apparatus may be a thermal transfer printer.

In accordance with yet another embodiment of the present invention, there is provided a computer readable recording medium storing a computer readable program for executing the image forming method for borderless printing.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an image forming apparatus for borderless printing according to an example embodiment of the present invention;

FIG. 2A illustrates an example display unit and an example user input unit included in the image forming apparatus shown in FIG. 1;

FIG. 2B illustrates an example image to be printed on a printable medium and marginal areas;

FIG. 2C illustrates an example image displayed on the display unit shown in FIG. 2A;

FIG. 3 is a diagram for explaining a method of setting bottom optimum borderless printing according to an example embodiment of the present invention;

FIG. 4 is a diagram for explaining the movement of a printer head in borderless printing according to an example embodiment of the present invention;

FIGS. 5A, 5B, and 5C are diagrams for explaining a method of adjusting image data in top or bottom optimum borderless printing according to an example embodiment of the present invention;

FIG. 6 is a diagram for explaining a method of setting right optimum borderless printing according to an embodiment of the present invention;

FIG. 7 is a schematic cross-sectional view of an image forming apparatus for explaining how a controller shown in FIG. 1 adjusts a print start position according to an example embodiment of the present invention;

FIGS. 8A, 8B, and 8C illustrate images printed using the right or left optimum borderless printing method according to an example embodiment of the present invention; and

FIG. 9 is a flowchart illustrating an image forming method for borderless printing according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

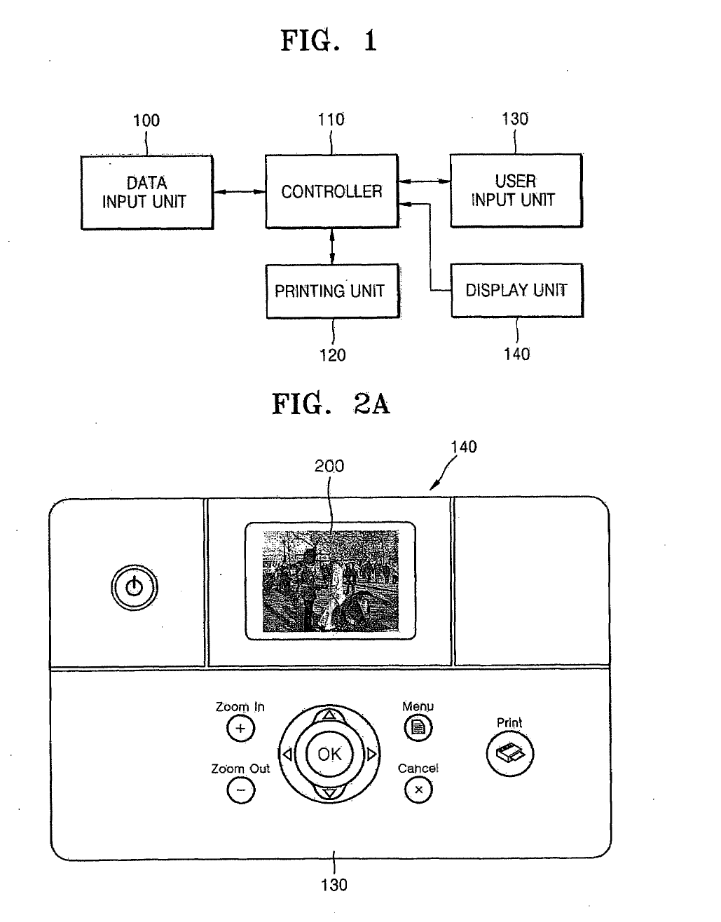

FIG. 1 is a block diagram of an image forming apparatus for borderless printing according to an example embodiment of the present invention. As shown in FIG. 1, the image forming apparatus comprises a data input unit 100, a controller 110, a printing unit 120, a user input unit 130, and a display unit 140. An operation of the image forming apparatus shown in FIG. 1 for borderless printing according to an example embodiment of the present invention will be described below.

The controller 110 controls a general operation of the data input unit 100, the printing unit 120, the user input unit 130, and the display unit 140.

The data input unit 100 receives image data to be printed from a host, such as a personal computer (PC), or an external storage medium readable by the image forming apparatus shown in FIG. 1. Such an external storage medium can be a compact flash (CF) memory card, a smart media (SM) memory card, an extreme digital (XD) memory card, a memory stick (MS), a secure digital (SD) memory card, or a multimedia card (MMC).

A storage unit (not shown), such as a hard disk drive (HDD), may also be included in the image forming apparatus, shown in FIG. 1, for storing image data input, via the data input unit 100.

When a user selects an image printing button, via the user input unit 130, the display unit 140 displays information on images stored in the storage unit (not shown), e.g., a thumbnail image of the images. When the user selects an image to be printed among the displayed images. via the user input unit 130, the display unit 140 displays the selected image to be printed on a printable medium, including top, bottom, left, and right marginal areas.

The marginal areas are top, bottom, left, and right end portions of a displayed image, which are included in the displayed image, but actually not printed on a printable medium, and represent areas generated by adjusting the size of the displayed image to be a little bit larger than the size of a print area, i.e., the size of the printable medium, so that no margin appears in the edge portions of a printed image.

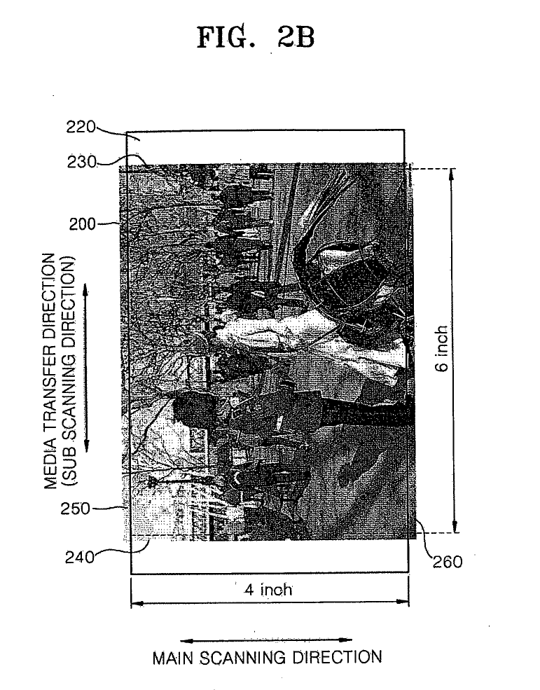

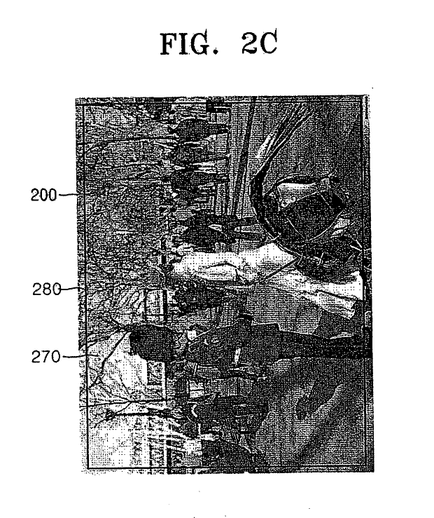

FIG. 2A illustrates an example image 200 of the display unit 140 and an example control buttons of the user input unit 130. The display unit 140 displays an image 200 selected by a user by identifying a print area of the image to be actually printed on a printable medium and marginal areas. The user input unit 130 includes, for example, zoom in/zoom out buttons, a menu button, a cancel button, a print button and main control button. Such a user input unit 130 allows the user to select an image 200 to be printed and adjust a position of the print area of a selected image 200 for printing on a printable medium.

FIG. 2B illustrates an image 200 to be printed on a printable medium and marginal areas. As shown in FIG. 2B, for example, a print size of a selected image 200 is 6×4 inches. A printable medium 220 has perforated lines along which the printable medium 220 will be cut off by the user in the left and right portions thereof, having wider than 6-inch width and 4-inch height. As described above, for the borderless printing, the size of an image is set a little bit larger than the printable medium 220, e.g., 0.8-inch larger than the printable medium 220 in each of the top, bottom, left, and right directions.

The direction in which the printable medium 220 is fed into the image forming apparatus, as shown in FIG. 1, is a sub scanning direction (i.e., media transfer direction), and the direction, which is perpendicular to the sub scanning direction, in which a printer head printing an image on the printable medium 220 is passed along from left to right is a main scanning direction. As described above, by forming an image a little bit larger than the printable medium 220, a top marginal area 250, a bottom marginal area, 260, a left marginal area 240, and a right marginal area 230, which are areas of an actually non-printed image, exist on the printable medium 220. Thus, a print area of a selected image 200 to be actually printed on the printable medium 220, as shown in FIG. 2B, is an area surrounded by the solid line of the printable medium 220 and the two perforated lines.

The user inputs a position of a print area, which is an area of a selected image 200 to be actually printed on a printable medium 220, via the user input unit 130.

FIG. 2C illustrates an image displayed on the display unit 200. In FIG. 2C, a print area 270 of a selected image 200 to be actually printed on a printable medium 220 is displayed separate from marginal areas by a rectangular solid line 280. The user can change a position of the rectangular solid line 280 indicating the print area 270 by operating up, down, left, and right buttons of the user input unit 130, thereby setting a position of the print area 270 of the selected image 200 to be actually printed on the printable medium 200. In another example embodiment of the present invention, the user can change a position of the selected image 200 by operating the up, down, left, and right buttons of the user input unit 130, thereby changing a position of the print area 270.

In another embodiment for inputting a position of the print area 270, the user can set the width of each of top, bottom, left, and right marginal areas of the displayed image 200 within a predetermined range. For example, if it is assumed that the default width of each of the top, bottom, left, and right marginal areas is 0.08 inches, the user can set each of the four marginal areas within a range between 0 and 0.16 inches. However, since the size of the magnified image and the size of the print area 270 are determined, if the width of the top/bottom marginal area 240, 260 is input, the width of the bottom/top marginal area 240, 260 is determined, and if the width of the left/right marginal area 240, 230 is input, the width of the right/left marginal area 240, 230 is determined.

In another example embodiment for inputting a position of the print area 270, the user can set a position of the print area 270 by inputting a position of one of the four vertices of the square 280 indicating the print area 270, as shown in FIG. 2C. For example, the user can set a position of the print area 270 by inputting a position of the up-right vertex of the print area 270 using the user input unit 130.

As shown in FIGS. 2B and 2C, since the print image is printed while feeding from a portion of the printable medium 220 corresponding to the left or right portion of the print image and transferring to the other portion of the printable medium 220 corresponding to the right or left portion of the print image, the top and bottom marginal areas 250, 260 are marginal areas of the main scanning direction, and the left and right marginal areas 230, 240 are marginal areas of the sub scanning direction.

The user can select top optimum borderless printing by inputting the width of the top marginal area 250 to be “0” so that the top marginal area of the displayed image does not exist. The user also can select bottom, left, or right optimum borderless printing by inputting the width of the bottom, left, or right marginal area 250, 240 or 230 to be “0”.

The input image data can be adjusted according to the position of the print area, which is input by the user, so that the print image of the print area desired by the user is printed on the printable medium 220.

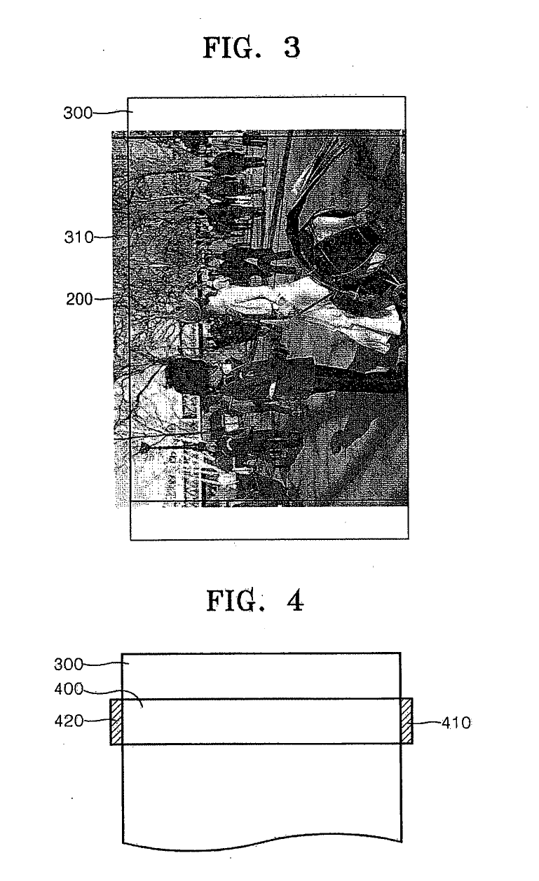

FIG. 3 is a result of a method of setting the bottom optimum borderless printing according to an example embodiment of the present invention. FIG. 3 is a result obtained when the user matches a solid line 310 indicating a print area with the bottom end line of a displayed image, via the user input unit 130. On the contrary, the user can set the top optimum borderless printing by matching the solid line 310 with the top end line of the displayed image, via the user input unit 130.

FIG. 4 is a diagram for explaining the movement of a printer head included in the printing unit 120, as shown in FIG. 1, in borderless printing according to an example embodiment of the present invention. As shown in FIG. 4, the print head comprises write components 400 printing an image in a print area, which is an area of a print image to be actually printed on a printable medium 300, write components 420 printing an image in the top marginal area 250, as shown, for example, in FIG. 2B, and write components 410 printing an image in the bottom marginal area 260, as shown, for example, in FIG. 2B.

In the borderless printing, without driving the write components 420 printing an image in the top marginal area 250 and the write components 410 printing an image in the bottom marginal area 260, only the write components 400 printing an image in the print area may be driven to print the print image on the printable medium 300. In another embodiment, one group of the write components 420 printing an image in the top marginal area and the write components 410 printing an image in the bottom marginal area may be not driven.

For example, in the case of a thermal transfer head included in the printing unit 120 having a 300-dpi (dots per inch) resolution and including 1248 heaters, each heater used to print a single dot, when a printing job is performed on a 6-inch×4-inch medium, 1200 heaters out of the 1248 heaters are used to print an image on the printable medium 220, and the left 24 heaters and the right 24 heaters are used to print an image 200 on the top and bottom marginal areas on the printable medium 220. Thus, the left 24 and right 24 write components 420 and 410 or one group of the left 24 and right 24 write components 420 and 410 may not be driven in the borderless printing.

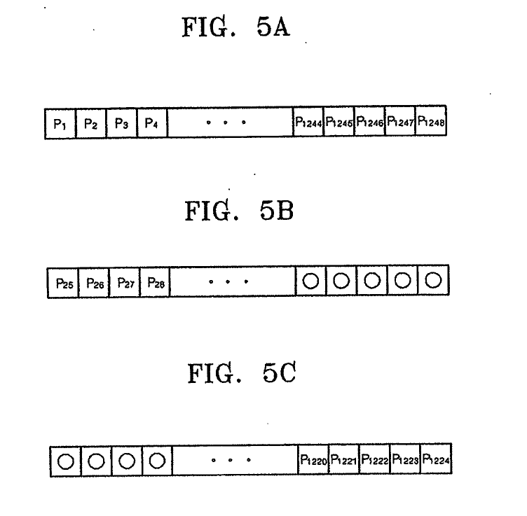

FIGS. 5A, 5B, and 5C are diagrams for explaining how image data is adjusted in the top or bottom optimum borderless printing according to an embodiment of the present invention. Here, a print head includes 1248 write components of which 48 write components are used to print an image in the top and bottom marginal areas.

Image data is input to the printing unit 120 in print line basis and stored in a line buffer (not shown). That is, as shown in FIG. 5A, the image data corresponding to the 1248 write components is stored in the line buffer (not shown).

FIG. 5B shows how the image data shown in FIG. 5A is adjusted by the controller 110, shown in FIG. 1, when the user selects the bottom optimum borderless printing. That is, FIG. 5B is obtained by the controller 110 shifting the 1248 image data P₁, P₂, P₃, . . . , P₁₂₄₆, P₁₂₄₇, and P₁₂₄₈ shown in FIG. 5A by 24 in the left direction. The controller 110 may not drive write components corresponding to an area in which an image is actually not printed on a printable medium 220 in the borderless printing by filling image data corresponding to the right 24 write components, which remains by shifting the image data in the left direction, with 0 (null) as shown in FIG. 5B.

FIG. 5C shows how the image data shown in FIG. 5A is adjusted by the controller 110, shown in FIG. 1, when the user selects the top optimum borderless printing. That is, FIG. 5C is obtained by the controller 110 shifting the 1248 image data P₁, P₂, P₃, . . . , P₁₂₄₆, P₁₂₄₇, and P₁₂₄₈ shown in FIG. 5A by 24 in the right direction. The controller 110 may not drive write components corresponding to an area in which an image is actually not printed on a printable medium 220 in the borderless printing by filling image data corresponding to the left 24 write components, which remains by shifting the image data in the right direction, with 0 (null) as shown in FIG. 5C.

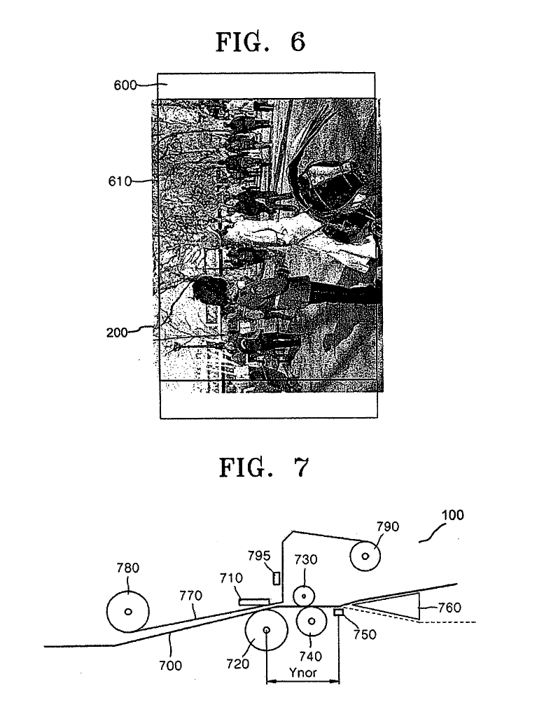

FIG. 6 is a result of a method of setting right optimum borderless printing according to an example embodiment of the present invention. FIG. 6 is a result obtained when the user matches a solid line 610 indicating a print area with the right end line of a displayed image using the user input unit 130. On the contrary, the user can set the left optimum borderless printing by matching the solid line 610 with the left end line of the displayed image. The borderless printing can be performed by adjusting the width of the left or right marginal area by the controller 110 adjusting a print start position at which a printer head starts to print an image on a printable medium 220.

FIG. 7 is a schematic cross-sectional view of a thermal transfer type image forming apparatus for explaining how a print start position is adjusted according to an example embodiment of the present invention. Such a print start position is adjusted by the controller 110, shown in FIG. 1. The image forming apparatus includes a thermal transfer head 710, a platen roller 720, drive rollers 730 and 740, a media sensor 750, a media guide 760, and ribbon rollers 780 and 790 which transport a ribbon 770. All components shown in FIG. 7 can be included in the printing unit 120, shown in FIG. 1.

The drive roller 740 transfers a printable medium 700 in the direction to the thermal transfer head 710 by rotating in conjunction with a motor (not shown), which is a drive source, and the drive roller 730 transfers the printable medium 700 by rotating in conjunction with the drive roller 740 in a state of placing the printable medium 700 between the drive rollers 730 and 740.

The thermal transfer head 710 heats the transferred medium 700 to print an image thereon, and the platen roller 720 faces the thermal transfer head 710 in a state of placing the printable medium 700 and a ribbon 770 between them, supports the printable medium 700 so that the ribbon 770 transfers a predetermined color onto the printable medium 700 in response to the heat, and rotates according to the transfer of the printable medium 700. The media sensor 750 senses that the printable medium 700 is fed, and the media guide 760 controls of a transfer path of the printable medium 700. The ribbon rollers 780 and 790 transfer the ribbon 770, and a ribbon sensor 795 senses the ribbon 770.

The controller 110 can adjust a print start position at which an image starts to be printed on the printable medium 700 by controlling the time from when the media sensor 750 senses the printable medium 700 to when the thermal transfer head 710 starts to heat the ribbon 770 and the printable medium 700. The time between the media sensing time and the media heating start time can be calculated using the print start position on the printable medium 700, a distance between the media sensor 750 and the thermal transfer head 710, and a transferring speed of the printable medium 700.

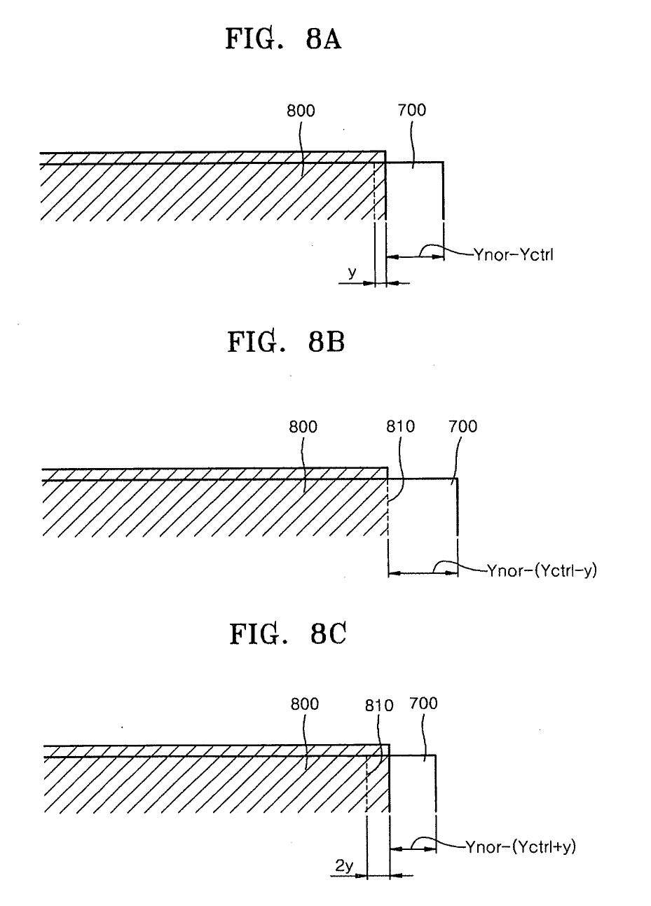

FIG. 8A illustrates a case of default settings in which the widths of left and right marginal areas of an image 800 are the same. As shown in FIG. 8A, the controller 110 determines a print start position of a printable medium 700 as (Yₙₒᵣ−Y_{ctrl}), and the width of the right marginal area is y. For example, if 1800 pixels are required to print an image of 6 inches in the left and right directions and an entire image is composed of 1848 pixels in the left and right directions, the value y is 0.08 inches.

As shown in FIG. 7, since Yₙₒᵣ has a constant value determined according to an image forming apparatus, the controller 110 can adjust a print start position of an image 800 on the printable medium 700 by determining the value Y_{ctrl}.

FIG. 8B illustrates an image 800 printed in the right optimum borderless printing. As shown in FIG. 8B, the controller 110 determines a print start position of a printable medium 700 as (Yₙₒᵣ−(Y_{ctrl}−y)), thereby matching the right end of an image 800 with a right perforated line 810 of the printable medium 700.

FIG. 8C illustrates an image 800 printed in the left optimum borderless printing. As shown in FIG. 8C, the controller 110 determines a print start position of a printable medium 700 as (Yₙₒᵣ−(Y_{ctrl}+y)), thereby matching the left end of an image 800 with a left perforated line (not shown) of the printable medium 700. Thus, in FIG. 8C, the width of the right marginal area is 2y.

As described above, the controller 110 can adjust the width of the right or left marginal area of an image 800 by adjusting Y_{ctrl}. Such an image 800 can then be printed on the printable medium 700, via the printing unit 120, by receiving the adjusted image data and information on the print start position from the controller 110.

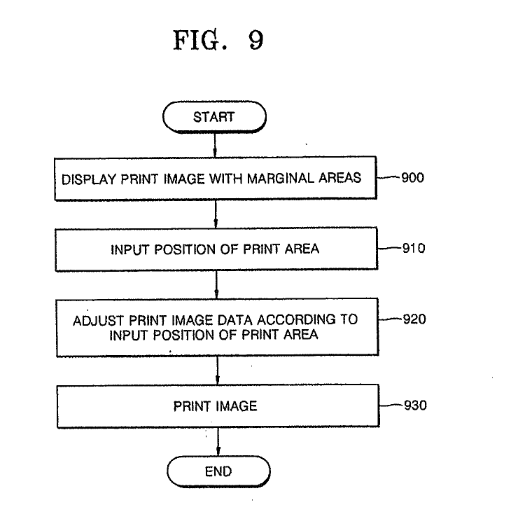

Turning now to FIG. 9, a flowchart of an image forming method for borderless printing according to an example embodiment of the present invention is illustrated. As shown in FIG. 9, when a user selects an image to be printed, via the user input unit 130, the selected image is displayed, via the display unit 140, including top, bottom, left and right marginal areas at operation 900. The user then inputs a position of a print area, which is an area of an image to be printed on a printable medium, via the user input unit 130, at operation 910.

At operation 920, print image data is adjusted according to the position of the print area, via the controller 110. Once adjusted, the print image of a print area desired by the user is printed on a printable medium.

As described above, a print area or marginal areas for the borderless printing can be set by a user using a user interface, which includes a user input unit and a display unit, included in an image forming apparatus or using an application program or a printer driver of a host.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

As described above, according to example embodiments of the present invention, when borderless printing is performed using an image forming apparatus, by allowing a user to adjust a position of a print area of a print image to be actually printed on a printable medium out of an image magnified than the size of the printable medium for the borderless printing, the user's convenience can be increased by easily preventing image data of an area desired by the user from not being printed, and by not driving write components of a printer head corresponding to marginal areas, power consumption can be reduced.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A borderless printing method comprising:
setting a print size of a print image and a print area of the print image from an image magnified than the print size for borderless printing; and
printing the print image on a printable medium according to the set print area.

2. The method of claim 1, wherein, during the setting of the print area, a position of the print area is input for at least one of top, bottom, left, and right portions of the print image.

3. The method of claim 1, wherein, during the setting of the print area, a position of one of vertices of the print area is input.

4. The method of claim 1, further comprising displaying the magnified image by dividing the magnified image into the print area and marginal areas.

5. The method of claim 4, wherein, during the setting of the print area, the print area is set by adjusting a position of the displayed print area.

6. The method of claim 1, wherein the printing comprises:
shifting print image data representing the print image on each print line according to the set print area; and
printing the print image by driving write components of a printer head using the shifted print image data.

7. The method of claim 1, wherein, during the printing, write components of the printer head corresponding to one of the two marginal areas of a main scanning direction are not driven.

8. The method of claim 1, wherein the printing comprises:
determining a print start position of the print image according to the set print area; and
printing the print image according to the determined print start position.

9. An image forming apparatus for borderless printing, comprising:
a user input unit arranged to enable a user to set a print size of a print image and a print area of the print image from an image magnified than the print size for borderless printing;
a controller arranged to adjust print image data representing the print image according to the set print area; and
a printing unit arranged to print the print image on a printable medium using the adjusted print image data.

10. The image forming apparatus of claim 9, wherein the user input unit receives a position of the print area for at least one of top, bottom, left, and right portions of the print image.

11. The image forming apparatus of claim 9, wherein the user input unit receives a position of one of vertices of the print area.

12. The image forming apparatus of claim 9, further comprising a display unit arranged to provide a visual display of the magnified image by dividing the magnified image into the print area and marginal areas.

13. The image forming apparatus of claim 9, wherein the printing unit comprises:
a printer head arranged to print the print image using a plurality of write components; and
a line buffer arranged to store print image data of a single print line corresponding to each of the write components,
wherein the controller shifts the print image data stored in the line buffer according to the set print area.

14. The image forming apparatus of claim 13, wherein the printer head does not drive write components corresponding to one of the two marginal areas of a main scanning direction.

15. The image forming apparatus of claim 9, wherein the controller determines a print start position of the print image according to the set print area.

16. A computer readable recording medium comprising instructions that, when executed by a computer system, perform the method comprising:
setting a print size of a print image and a print area of the print image from an image magnified than the print size for borderless printing; and
printing the print image on a printable medium according to the set print area.

17. The computer readable recording medium of claim 16, further comprising:
receiving input of one of a position of the print area for at least one of top, bottom, left, and right portions of the print image, and a position of one of vertices of the print area, during setting the print size of the print image.

18. The computer readable recording medium of claim 16, further comprising:
displaying the magnified image by dividing the magnified image into the print area and marginal areas.

19. The computer readable recording medium of claim 16, wherein the printing comprises:
shifting print image data representing the print image on each print line according to the set print area; and
printing the print image by driving write components of a printer head using the shifted print image data.

20. The computer readable recording medium of claim 16, wherein, during the printing, write components of the printer head corresponding to one of the two marginal areas of a main scanning direction are not driven.

21. The computer readable recording medium of claim 16, wherein the printing comprises:
determining a print start position of the print image according to the set print area; and
printing the print image according to the determined print start position.

22. A printing method of an image forming apparatus comprising:
forming an image to be printed on a printable medium that is larger than the printable medium;
displaying the image including a print area of the image to be printed on the printable medium and marginal areas at a perimeter of the image that are not to be printed on the printable medium;
enabling a user, via a user interface, to set the print area of the image to be printed on the printable medium; and
printing the print area of the image on the printable medium according to the set print area.

23. The printing method of claim 22, wherein the print area is set by adjusting a position of the print area of the image, via the user interface, for at least one of top, bottom, left, and right portions of the image.

24. The printing method of claim 22, wherein the print area is set by moving a position of one of vertices of the image indicating the print area, via the user interface.

25. The printing method of claim 22, further comprising:
enabling the user, via the user interface, to set each of top, bottom, left and right marginal areas of the image within a predetermined range.

26. The printing method of claim 22, wherein the printing comprises:
shifting print image data representing the image on each print line according to the set print area; and
printing the print area of the image by driving write components of a printer head using the shifted print image data,
wherein write components of the printer head corresponding to the marginal areas of a main scanning direction are not driven.

27. An image forming apparatus comprising:
a print head comprising a plurality of write components selectively driven to print a print area of a print image on a printable medium; and
a controller arranged to form the print image to be printed on the printable medium that is larger than the printable medium, to provide a visual display of the print image including the print area of the print image to be printed on the printable medium and marginal areas at a perimeter of the print image that are not to be printed on the printable medium, to set the print area of the print image to be printed on the printable medium in accordance with a user's instruction, and to drive selected write components of the print head corresponding to the print area so as to print the print area of the image on the printable medium according to the set print area.

28. The image forming apparatus of claim 27, further comprising:
a display unit arranged to display the print image including the print area of the print image to be printed on the printable medium and the marginal areas at a perimeter of the print image that are not to be printed on the printable medium; and
a user input unit arranged to enable a user to set a print size and the print area of the print image from the print image displayed for borderless printing by moving a position of the print area for at least one of top, bottom, left, and right portions of the print image or by moving a position of one of vertices of the print image indicating the print area.

29. The image forming apparatus of claim 27, further comprising:
a line buffer arranged to store image data representing the print image of a single print line corresponding to each of the write components in the print head,
wherein the controller further shifts the image data stored in the line buffer according to the set print area.

30. The image forming apparatus of claim 27, wherein the print head does not drive write components corresponding to one of the two marginal areas of a main scanning direction.
